(19) United States
(12) Patent Application Publication
(10) Pub. No.: US 2006/0270381 A1
(43) Pub. Date: Nov. 30, 2006

(54) WIRELESS RECEIVER

(75) Inventors: Tah Joon Park, KYUNGKI-DO (KR); Jin Baek Song, KYUNGKI-DO (KR); Eung Ju Kim, KYUNGKI-DO (KR); Joong Jin Kim, KYUNGKI-DO (KR)

Correspondence Address: LOWE HAUPTMAN BERNER, LLP, 1700 DIAGONAL ROAD, SUITE 300, ALEXANDRIA, VA, 22314, US

(73) Assignee: SAMSUNG ELECTRO-MECHANICS CO., LTD., KYUNGKI-DO (KR)

(21) Appl. No.: 11/420,726

(22) Filed: May 26, 2006

(30) Foreign Application Priority Data
May 27, 2005 (KR) 10-2005-0045101

(51) Int. Cl. H04B 1/16

(52) U.S. Cl. 455/343.2

(57) ABSTRACT

The invention relates to a wireless receiver which is enabled upon receiving a specific identification signal to receive data, and more particularly, which minimizes power consumption in an idle state and accurately discriminate the specific identification signal. The wireless receiver which receives the specific identification signal to enable a main transceiver for transmitting and receiving data includes a signal detector for receiving a signal in a particular frequency band to output a first wake-up signal, and an identification detector which is enabled by the first wake-up signal, decoding a signal in a particular frequency band, and discriminating whether or not the decoded signal is the identification signal to enable the main transceiver.

### CLAIM OF PRIORITY

This application claims the benefit of Korean Patent Application No. 2005-45101 filed on May 27, 2005, in the Korean Intellectual Property Office, the disclosure of which is incorporated herein by reference.

### BACKGROUND OF THE INVENTION

1. Field of the Invention

The present invention relates to a wireless receiver which enables a main transceiver for sending and receiving data upon receiving a predetermined identification signal, and more particularly, a wireless receiver capable of precisely discriminating the predetermined identification signal and reducing power consumption while in an idle state.

2. Description of the Related Art

A wireless receiver is a device for receiving digital or analogue information as a wireless signal in a predetermined frequency band. In such a wireless receiver, power consumption is an important index of its capability. In the case where the wireless transceivers is provided in a device using a battery such as a mobile phone and a Personal Data Assistant (PDA), the power consumption ratio of the wireless receiver is especially important because communication time is affected by the amount of power consumption. Moreover, as the recent network system such as Zigbee requires a low-power design, there have been researches on reduction of power consumption in the wireless receiver.

The most general way to reduce power consumption is to turn off the largest transceiver in an idle state and turn it on only when receiving a predetermined identification signal to receive data. Thus, the wireless receiver needs to have a means for turning on or off the main transceiver when receiving the predetermined identification signal, in addition to a main transceiving circuit for receiving wireless signals containing information.

FIG. 1 illustrates an example of a conventional wireless receiver, which is disclosed in “Personal Wireless Transmitter and Receiver to Save Battery Power,” Utility Model Application Publication No. 1999-22851. The wireless receiver in FIG. 1 has a radio frequency (RF) direct detector 11 for detecting a wake-up signal higher than a general radio frequency signal containing information. The RF direct detector 11 sends the detected wake-up signal to a Central Processing Unit (CPU) 12, which then regulates a power supplier 13 to supply power to an RF receiver 15 and a signal demodulator 16, to thereby receive a general RF signal containing the actual information.

Power is not applied during ordinary times to the RF receiver 15 and the signal demodulator 16 which consumes the highest current, but only applied to operate the RF direct detector 11 and the CPU. Only when the predetermined identification signal is received at the RF direct detector, power is applied to the RF receiver 15 and the signal demodulator 16, reducing overall current consumption.

However, since the above conventional wireless receiver uses a signal in a particular frequency band as a wake-up signal, there may be times when the wake-up signals are not detected due to interference of other signals. Moreover, constant operation of the CPU 12, memory, etc. is required to discriminate other wake-up signals.

The wireless receiver shown in FIG. 1 has a power consumption pattern as shown in FIG. 2.

As shown in FIG. 2(a), given that a wake-up signal is received at t0 and data is received at t1, the RF direct detector 11 and the CPU 12 of the wireless receiver in FIG. 1 are operated to receive awake-up signal, and thus there is basic consumption of current A1. After the wake-up signal is received and then the data is beginning to be received, power is applied to operate the RF receiver 15 and the signal modulator 16, and thus there occurs greater consumption of current A2.

As a result, a predetermined or higher current is consumed even in an idle state, and therefore power is not sufficiently saved.

### SUMMARY OF THE INVENTION

The present invention has been made to solve the foregoing problems of the prior art and it is therefore an object of the present invention to provide a wireless receiver which can reduce power consumption in an idle state in which data is not received while accurately discriminating a predetermined identification signal to enable a main transceiving circuit.

According to an aspect of the invention for realizing the object, there is provided a wireless receiver, which enables a main transceiver sending and receiving data upon receiving a specific identification signal, including: a signal detector for receiving a wireless signal in a predetermined frequency band, and if the received wireless signal is above a reference level, outputting a first wake-up signal; and an identification detector, enabled by the first wake-up signal of the signal detector, for decoding a wireless signal in a predetermined frequency band with a SAW correlator, and determining whether or not the decoded signal is a predetermined specific identification signal, and if the decoded signal is a predetermined signal, outputting a second wake-up signal to enable the main transceiver.

In the wireless receiver according to the present invention, the signal detector includes: a buffer for receiving a wireless signal received at an antenna; a highly band selective high gain amplifier for amplifying a signal in a predetermined frequency band among the signals outputted from the buffer; a level detector for determining whether or not the signal outputted from the highly band selective high gain amplifier is above the reference level, and if the signal from the highly band selective high gain amplifier is above the reference level, outputting the first wake-up signal. In addition, in the wireless receiver according to the present invention, the signal detector includes: an adder for adding a signal received at the antenna to a feedback signal; an amplifier turned on/off by a quench, for amplifying an output signal from the adder; a feedback network for feeding back an output signal from the amplifier to the adder; an envelope detector for detecting an envelope curve of the output signal from the amplifier; a low pass filter for filtering an output signal from the envelope detector to eliminate noise; and a level detector for determining whether or not the level of the output signal from the low pass filter is above the reference level, and if the level of the output signal from the low pass filter is above the reference level, outputting the first wake-up signal.

The above described signal detector further includes a power regulator for turning off the adder and the amplifier as the first wake-up signal is outputted from the level detector.

Moreover, in the wireless receiver according to the present invention, the signal detector includes: a super-regenerative oscillator oscillating by a signal received at the antenna; and a level detector for determining whether or not the level of the oscillating signal outputted from the super-regenerative oscillator is above the reference level, and if the level of the oscillating signal is above the reference level, outputting the first wake-up signal.

In addition, in the wireless receiver according to the present invention, the identification detector includes: a first buffer for receiving a signal received at an antenna; a first highly band selection high gain amplifier for filtering a signal in a predetermined frequency band among the output signals of the first buffer; a SAW correlator for decoding an output signal from the first highly band selection high gain amplifier; a second buffer for receiving an output signal from the SAW correlator; a second highly band selection high gain amplifier for amplifying an output signal from the second buffer; and a wake-up signal detector for determining whether or not an output signal from the second highly band selection high gain amplifier is a predetermined signal, and if the output signal from the second highly band selection high gain amplifier is a predetermined signal, outputting the second wake-up signal.

In the wireless receiver according to the present invention, the identification detector includes: a low noise amplifier for low-noise amplifying a signal received at the antenna; a SAW correlator for encoding the signal outputted from the low noise amplifier to detect a specific identification signal; a high gain amplifier for amplifying a signal outputted from the SAW correlator to a high gain; awake-up signal detector for determining whether or not a predetermined identification signal is received based on the output signals from the high gain amplifier to output the second wake-up signal for regulating the power of the main transceiver.

The above described wake-up signal detector includes a peak detector for detecting a peak level of the signal decoded by the SAW correlator, and if the peak level of the signal is above a predetermined level, outputting the second wake-up signal. Alternatively, the wake-up signal detector includes: an envelope detector for detecting an envelope curve of a signal decoded by the SAW correlator; a low pass filter for eliminating a high pass noise from the signal outputted from the envelope detector; an identification detector for determining whether or not the envelope curve passed through the low pass filter is a predetermined identification signal to output the second wake-up signal.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a functional block diagram illustrating a conventional wireless receiver;

FIG. 2 is a graph showing a current consumption pattern of the conventional wireless receiver;

FIG. 3 is a functional block diagram illustrating a basic concept of a wireless receiver according to the present invention;

FIG. 4 is a graph illustrating a current consumption pattern of the wireless receiver according to the present invention;

FIG. 5 is a block diagram illustrating an exemplary wireless receiver according to the present invention;

FIG. 6 is a detailed circuit diagram illustrating a buffer and a highly band selection high gain amplifier provided in the wireless receiver shown in FIG. 5;

FIG. 7 is a block diagram illustrating an exemplary signal detector of the wireless receiver according to the present invention;

FIG. 8 is a block diagram illustrating another exemplary signal detector of the wireless receiver according to the present invention; and

FIG. 9 is a block diagram illustrating an exemplary ID detector of the wireless receiver according to the present invention.

FIGS. 10a and 10b illustrate specific embodiments of the wake-up signal detector provided in the ID detector.

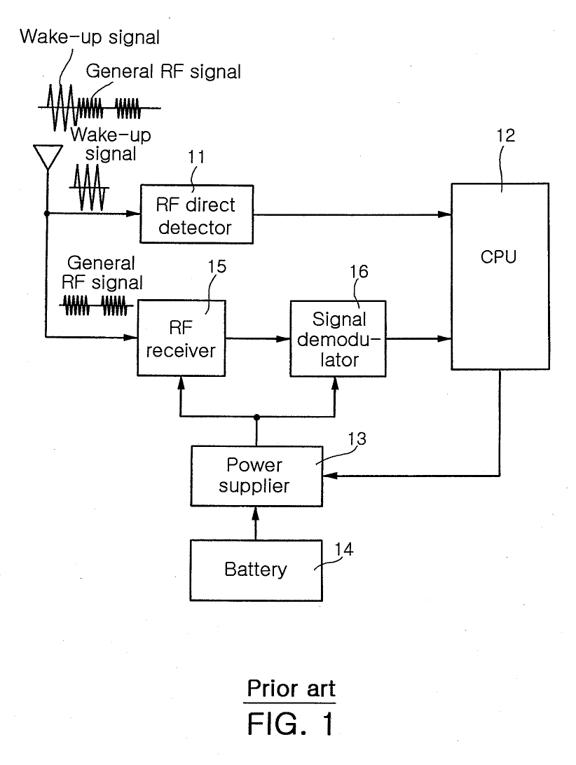

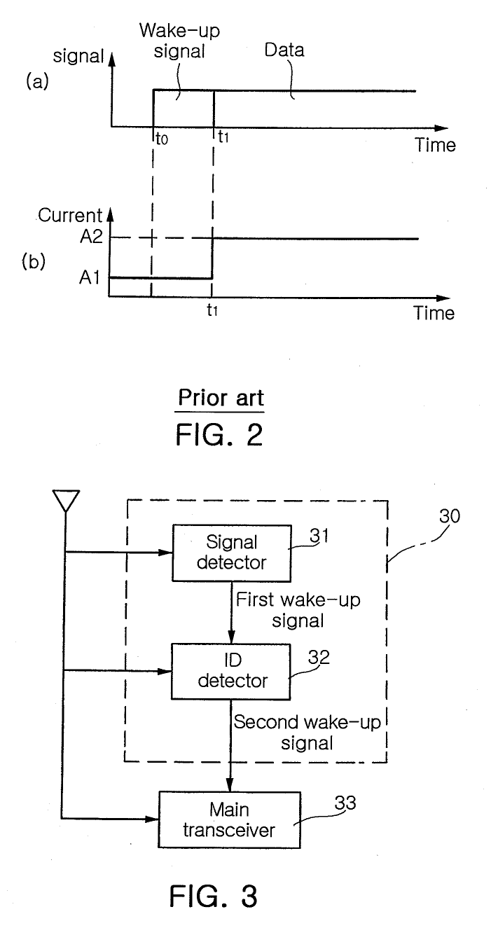

### DETAILED DESCRIPTION OF THE PREFERRED EMBODIMENT

The following description will present a wireless receiver according to the present invention with reference to the accompanying drawings.

FIG. 3 is a functional block diagram illustrating the basic concept of the wireless receiver according to the present invention.

With reference to FIG. 3, the overall configuration of the wireless receiver according to the present invention includes a signal detector 31, an identification (ID) detector 32 and a main transceiver 33. The signal detector 31 is adapted to receive a wireless signal in a predetermined frequency band, and if the received signal is above a reference level, to output a first wake-up signal. The ID detector 32 is operated by the power applied in accordance with the first wake-up signal to decode the wireless signal in the predetermined frequency band by a SAW correlator, and if the decoded signal is a predetermined identification signal, to output a second wake-up signal. The main transceiver 33 is operated by power applied in accordance with the second wake-up signal to receive information through a predetermined frequency band.

The signal detector 31 is provided with only a function of receiving a signal in a predetermined frequency band, and can be simply realized with an amplifier or a filter circuit, operable with minimal current. In addition, the signal detector 31 is configured to determined that it received a corresponding frequency signal when the predetermined band of signal is above a predetermined level, thus preventing the ID detector 32 from being activated by a noise signal.

The wireless receiver according to the present invention operates only the signal detector 31 at ordinary times to determine whether or not a signal is received in a frequency band in which the identification signal for the wireless receiver is transmitted. Power is blocked from being applied to the ID detector 32 and the main transceiver 33 at this point, and thus there occurs no current consumption.

In addition, if the signal detector 31 receives a signal in a particular frequency band above the reference level, it outputs the first wake-up signal to activate the ID detector 32 while simultaneously converting itself to an “off” state to preclude unnecessary power consumption. It is desirable that the signal detector 31 is configured such that it converts to an “on” state when both the ID detector 32 and the main transceiver 33 are off.

The ID detector 32 is activated by the first wake-up signal to decode the received signal by a SAW correlator, determining whether or not a predetermined identification signal was received from the decoded signal to output the second wake-up signal to the main transceiver 33. The signal detector 31 and the main transceiver 33 maintain an “off” state until the second wake-up signal is outputted, and thus the current consumption occurs only in the ID detector 32.

The main transceiver 33 is activated by the second wake-up signal, carrying out functions of a general receiver. When the main transceiver 33 is turned “on,” the wireless receiver carries out data receiving operation in a normal manner.

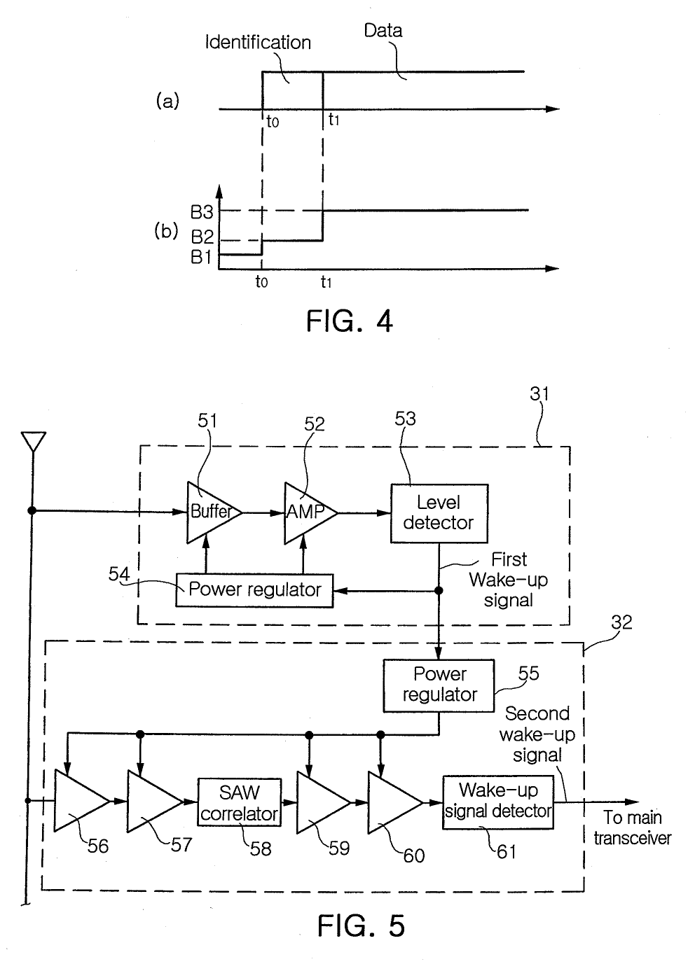

The wireless receiver which conducts the signal detection and identification detection step by step as described above, has a current consumption pattern in three stages as shown in FIG. 4.

In the first stage, the signal detector 31 is operated to receive a wireless signal in a predetermined frequency band, and the smaller consumption of current B1 is consumed.

In the second stage, the wireless signal in the predetermined frequency band is received to enable the ID detector 32, and the current B2 higher than B1 is consumed.

In the third stage, the wireless signal in a particular frequency band is recognized as a predetermined identification signal to operate the main transceiver 33. Here, current consumption takes place only at the main transceiver, and the consumption of current B3 is exhibited in this stage.

Here, the signal detector 31 only checks the level of the signal in the predetermined frequency band without carrying out such detection function conducted by an oscillator, frequency converter, etc. Thus, compared with the conventional RF direct detector 11, it is simpler in its circuit configuration, consuming a lower current. Therefore, the wireless receiver according to the present invention is able to further reduce the power consumption during a long period of idle state. As a result, it can satisfy the condition of low power required by Zigbee, etc.

In addition, the ID detector 32 uses only the SAW correlator to discriminate the identification signal, without having RF circuit elements such as a mixer, a Phase Locked Loop (PLL) and an oscillator. Thus, it consumes a lower current than the conventional RF direct detector 11 having a mixer, a PLL, and an oscillator while being less susceptible to interference with enhanced discriminating ability.

FIGS. 5 to 10 illustrate the specific configurations of the wireless receiver having functions and operations as explained hereinabove.

FIG. 5 illustrates a first embodiment of the wireless receiver according to the present invention. As shown, the signal detector 31 of the wireless receiver includes: a buffer 51 for receiving a wireless signal received at an antenna; a highly band selection high gain amplifier 52 for amplifying a signal in a particular frequency band among the signals received at the antenna; a level detector 53 for identifying the level of an output signal from the highly band selection high gain amplifier 52 and if the level of the output signal is above the reference level, outputting a first wake-up signal; and a power regulator 54 for turning off the buffer 51 and the highly band selection high gain amplifier 52 as the first wake-up signal is outputted.

As described above, the signal detector 31 is realized with only the buffer 51, amplifier 52 and level detector 53, consuming a very low current. When the wireless signal of the particular frequency band is received, the signal detector 31 activates the ID detector 32 while turning off itself, preventing unnecessary power consumption.

In addition, the ID detector 32 includes a first buffer 56 for receiving a signal received at the antenna, a first highly band selection high gain amplifier 57 for filtering a signal in a particular frequency band among the output signals of the first buffer 56, a SAW correlator 58 for decoding the signal outputted from the first highly band selection high gain amplifier 57, a second buffer 59 for receiving the decoded signal outputted from the SAW correlator 58, a second highly band selection high gain amplifier 60 for amplifying an output signal from the second buffer 59, and a wake-up signal detector 61 for determining whether or not an output signal from the second highly band selection high gain amplifier 60 is a predetermined signal to output a second wake-up signal.

The SAW correlator 58 is a SAW filter having a specific pattern, outputting a pulse signal when a predetermined signal is inputted. Here, the predetermined signals are, for example, up chirp signal, down chirp signal, encoded SAW correlation signal, etc. The SAW correlator 58 has a decoding pattern corresponding to a predetermined discrimination signal. The wake-up signal detector 61 may simply be configured to detect the level of the decoded signal from the SAW correlator 58, and if the level of the decoded signal is above the reference level, to determine that the discriminating signal is received. Alternatively, the wake-up signal detector 61 can be configured to detect an envelope curve of the signal decoded by the SAW correlator 58, and if the envelope curve is a predetermined form, to determine as having received the identification signal.

The highly band selection high gain amplifier 52 of the signal detector 31 and the highly band selection high gain amplifier 57 and 60 of the ID detector 32 can be realized with the same circuit, in which a signal in a particular frequency band is amplified while suppressing an outband signal, having enhanced blocking ability against interference. In this embodiment, the highly band selection high gain amplifier 52 is realized via a regenerative amplifier structure.

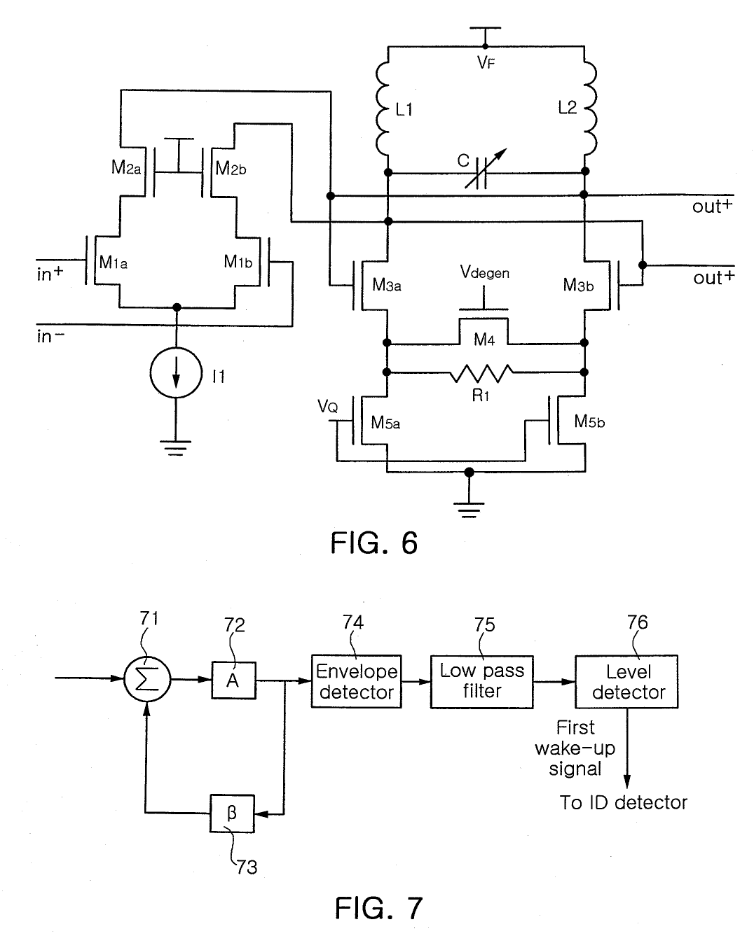

FIG. 6 is a detailed circuit of the buffer 51, 56 and 59 and the highly band selection high gain amplifier 52, 57 and 60.

In FIG. 6, FET transistors M1a, M1b, M2a and M2b constitute the buffers 51, 56 and 59, and the circuit composed of 5 FET transistors M3a, M3b, M4, M5a, and M5b and RLC elements R1, L1, L2 and C constitute the highly band selection high gain amplifiers 52, 57 and 60.

That is, the frequency signal applied to the input end in+, in− is constant-voltage amplified through the FET transistor M1a, M1b and the FET transistor M2a, M2b to be applied to the FET transistor M3a, M3b.

At this point, the coils L1, L2 and the capacitor C resonate in response to a particular frequency band, attenuating the outband signal. Therefore, the signal in the predetermined frequency band among the received signals is amplified by the FET transistors M3a, M3b, M4, M5a, M5b to be outputted through the output ends out+ and out−.

In addition, the signal detector 31 according to the present invention further includes a power regulator 54 for turning on or off the buffer 51 and the highly band selection high gain amplifier 52, thereby turning off the buffer 51 and the highly band selection high gain amplifier during the operation of the ID detector 32, reducing unnecessary power consumption.

Applying the embodiment shown in FIG. 5, the current consumption levels B1 and B2 in the first and second stages, respectively, can be calculated as follows. The current consumption B1 equals “{current consumption of buffer 51+current consumption of amplifier 52}×clock duty+current consumption of detector 53”. In addition, the current consumption B2 equals “{current consumption of buffer+current consumption of highly band selection high gain amplifier}×2+current consumption of envelope detector”, supposing that the current consumption levels of the first and second buffers 56 and 59 are the same, and the current consumption levels of the first and second highly band selection high gain amplifiers 57 and 60 are the same.

The wireless receiver according to the above-described embodiment has the highly band selection high gain amplifiers 52, 57 and 60 to minimize the problem of interference and allows realization of the pair of buffers 51, 56 and 59 and the highly band selection high gain amplifiers 52, 57 and 60 into a single chip, reducing the size.

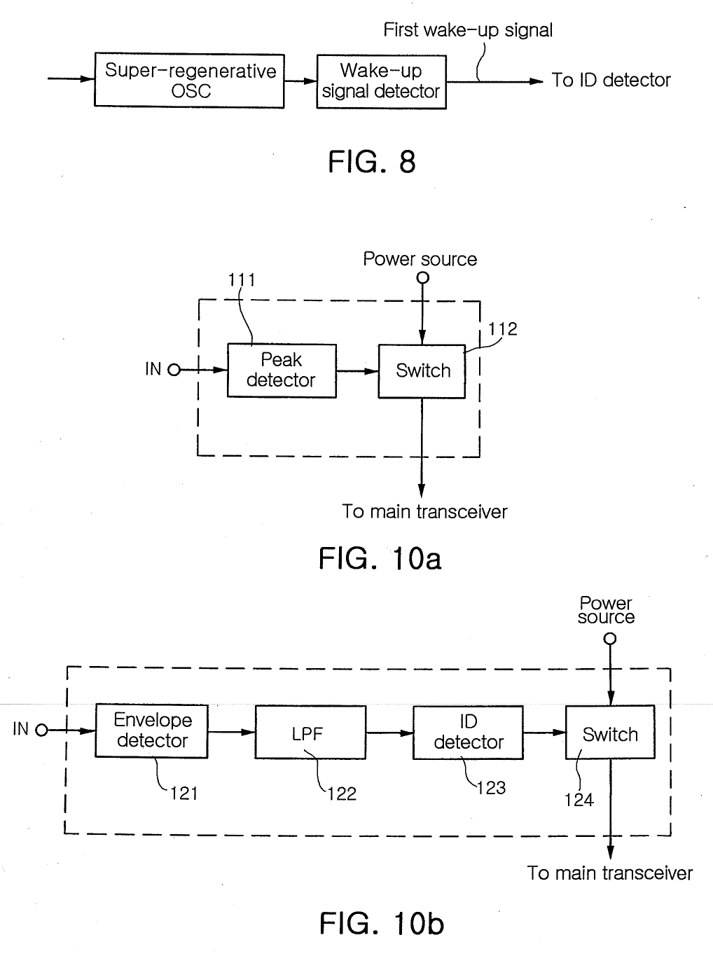

FIGS. 7 and 8 are block diagrams illustrating an embodiment of the signal detector 31.

First, with reference to FIG. 7, the signal detector 31 includes: an adder 71 for adding a signal received at an antenna to a feedback signal; an amplifier 72, turned on or off by a quench, for amplifying an output signal from the adder 71; a feedback network 73 for feeding back an output signal from the amplifier 72 to the adder 71; an envelope detector 74 for detecting an envelope curve outputted from an output signal from the amplifier 72; a low pass filter 75 for filtering an output signal from the envelope detector 74 to eliminate noise; and a level detector 76 for confirming the level of the signal outputted from the low pass filter 75, and if the level of the output signal is above a reference level, outputting a first wake-up signal which turns on or off the power of the ID detector 32.

As mentioned above, the signal detector 31 may further include a power regulator for turning off the adder 71 and the amplifier 72 as the first wake-up signal is outputted from the level detector 76.

The signal detector 31 with the above configuration accumulates and amplifies the signal passed through the adder 71, the amplifier 72 and the feedback network 73 when the signal is received at the antenna. At this point, when a wireless signal in a predetermined frequency band containing the identification signal is received, the output level of the amplifier 72 is increased. The envelope detector 74 detects such a change in level, and the detected envelope signal is applied through the low pass filter 75 to the level detector 76. The level detector 76 confirms the level of the signal outputted from the low pass filter 75, and if the peak value is above a predetermined level, outputs the first wake-up signal to the ID detector 32.

FIG. 8 is a block diagram illustrating another embodiment of the signal detector 31 realized using a super-regenerative oscillator.

With reference to FIG. 8, the signal detector 31 includes a super-regenerative oscillator 81 which oscillates in response to a signal received at the antenna, and a level detector 82 for confirming the level of the output signal from the super-regenerative oscillator 81 and if the level of the output signal is above a predetermined level, outputting the first wake-up signal to the ID detector 32.

The super-regenerative oscillator 81 is turned on and off in a predetermined cycle, oscillated by the received signal. At this point, it oscillates in response to general white noise level as well as a signal of particular frequency band but the level is increased more rapidly in response to the signal in a particular frequency band. That is, being turned on and off in a predetermined cycle, the super-regenerative oscillator 81 does not exhibit an output level above a predetermined reference value in response to the white noise, but exhibits an output level increase above the predetermined reference value in response to the signal in a particular frequency band. Therefore, the level detector 82 confirms whether the level of the outputted signal from the super regenerative oscillator 81 is above the reference value to determine whether or not the signal of particular frequency band is received.

The first wake-up signal outputted from the signal detector 31 regulates the power applied to the ID detector 32. That is, some type of switching element may be provided at the power source end applied to the ID detector 32, and the switching element may be set up to be turned on by the first wake-up signal to enable the ID detector 32.

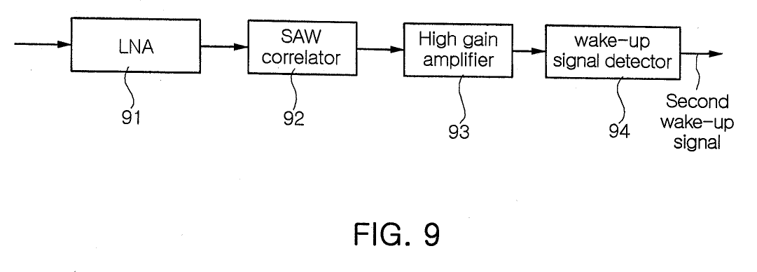

Next, FIG. 9 illustrates an embodiment of the ID detector 32.

With reference to FIG. 9, the ID detector 32 includes: a low noise amplifier 91 for low-noise amplifying a signal received at an antenna; a SAW correlator 92 for encoding an output signal from the low-noise amplifier 91 to detect a particular identification signal; a high gain amplifier 93 for amplifying an output signal from the SAW correlator 92 to a high gain; and a wake-up signal detector 94 for determining from an output signal of the high gain amplifier 33 whether a predetermined identification signal is received, and outputting a second wake-up signal which regulates the power to the main transceiver 33.

In the above configuration, the low noise amplifier 91 restrains noise while amplifies and outputs a signal of particular frequency band, which can be embodied by the highly band selection high gain amplifier shown in FIG. 6.

In addition, as explained with reference to FIG. 5, the SAW correlator 92 is a SAW filter, having a predetermined pattern. In case of the identification signals such as up chirp signal, down chirp signal, encoded SAW correlation signal are received, it decodes such to output a particular pulse signal.

The wake-up signal detector 94 can simply be configured to detect the level of decoded signal from the SAW correlator 92, and if the level of the decoded signal is above the reference level, to judge as having received a predetermined identification signal. Also, it can be configured to detect an envelope curve of the decoded signal from the SAW correlator 92, and if the envelope curve is a predetermined form, to determine as having received the identification signal.

The specific constitution of the above described wake-up signal detector 94 is illustrated in FIGS. 10a to 10b.

FIGS. 10a and 10b illustrate specific embodiments of the wake-up signal detector 61 and 94, respectively, provided in the ID detector 32. As shown in FIG. 10a, the signal detector 61 and 94 includes a peak detector 111 for detecting a peak level of the decoded signal from the SAW correlator 58 and 92, and if the peak level is above a predetermined level, outputting a second wake-up signal, and a switch 112 turned on by the second wake-up signal to apply power to the main transceiver 33. In addition, as shown in FIG. 10b, the wake-up signal detector 61 and 94 can also include an envelope detector 121 for detecting an envelope curve of the decoded signal from the SAW correlator 58 and 92, a low pass filter 122 for eliminating high pass noise from the signal outputted from the envelope detector 121, ID detector 123 for determining whether or not the envelope curve passed through the low pass filter 122 is a predetermined identification signal to output a second wake-up signal, and a switch 124 which turned on by the second wake-up signal outputted from the ID detector 123 to apply power to the main transceiver 33.

According to the above configuration, the wireless receiver is able to discriminate an identification signal via the SAW correlator. Therefore, there is no need for a mixer, oscillator, etc., further decreasing the power consumption. In addition, as the SAW correlator is used to determine the identification signal, the avoiding ability of interference is enhanced maximally.

As set forth above, the wireless receiver according to present invention is able to minimize the power consumption in an idle state when no data is received. Moreover, the wireless receiver discriminates the identification signal for enabling the main transceiver via the SAW correlator, maximizing the avoiding ability of the interference to prevent malfunction by the interfering signal. As a result, unnecessary power consumption is reduced to further reduce the total unnecessary power consumption.

While the present invention has been shown and described in connection with the preferred embodiments, it will be apparent to those skilled in the art that modifications and variations can be made without departing from the spirit and scope of the invention as defined by the appended claims.

What is claimed is:

1. A wireless receiver, which enables a main transceiver sending and receiving data upon receiving a specific identification signal, comprising:
a signal detector for receiving a wireless signal in a predetermined frequency band, and if the received wireless signal is above a reference level, outputting a first wake-up signal; and
an identification detector, enabled by the first wake-up signal of the signal detector, for decoding a wireless signal in a predetermined frequency band with a SAW correlator, and determining whether or not the decoded signal is a predetermined specific identification signal, and if the decoded signal is a predetermined signal, outputting a second wake-up signal to enable the main transceiver.

2. The wireless receiver according to claim 1, wherein the signal detector comprises:
a buffer for receiving a wireless signal received at an antenna;
a highly band-selective high-gain amplifier for amplifying a signal in a predetermined frequency band among the signals outputted from the buffer;
a level detector for determining whether or not the signal outputted from the highly band selective high-gain amplifier is above the reference level, and if the signal from the highly band selection high gain amplifier is above the reference level, outputting the first wake-up signal.

3. The wireless receiver according to claim 2, wherein the signal detector further comprises a power regulator for turning off the buffer and the highly band-selective high gain amplifier upon being applied with the first wake-up signal from the level detector.

4. The wireless receiver according to claim 1, wherein the signal detector comprises:
an adder for adding a signal received at the antenna to a feedback signal;
an amplifier start/stop its oscillation by a quench, for amplifying an output signal from the adder;
a feedback network for feeding back an output signal from the amplifier to the adder;
an envelope detector for detecting an envelope curve of the output signal from the amplifier;
a low pass filter for filtering an output signal from the envelope detector to eliminate noise; and
a level detector for determining whether or not the level of the output signal from the low pass filter is above the reference level, and if the level of the output signal from the low pass filter is above the reference level, outputting the first wake-up signal.

5. The wireless receiver according to claim 4, wherein the signal detector further comprises a power regulator for turning off the adder and the amplifier as the first wake-up signal is outputted from the level detector.

6. The wireless receiver according to claim 1, wherein the signal detector comprises:
a super-regenerative oscillator oscillating by a signal received at the antenna; and
a level detector for determining whether or not the level of the oscillating signal outputted from the super-regenerative oscillator is above the reference level, and if the level of the oscillating signal is above the reference level, outputting the first wake-up signal.

7. The wireless receiver according to claim 1, wherein the identification detector comprises:
a first buffer for receiving a signal received at an antenna;
a first highly band selection high gain amplifier for filtering a signal in a predetermined frequency band among the output signals of the first buffer;
a SAW correlator for decoding an output signal from the first highly band selection high gain amplifier;
a second buffer for receiving an output signal from the SAW correlator;
a second highly band selection high gain amplifier for amplifying an output signal from the second buffer; and
a wake-up signal detector for determining whether or not an output signal from the second highly band selection high gain amplifier is a predetermined signal, and if the output signal from the second highly band selection high gain amplifier is a predetermined signal, outputting the second wake-up signal.

8. The wireless receiver according to claim 1, wherein the identification detector comprises:
a low noise amplifier for low-noise amplifying a signal received at the antenna;
a SAW correlator for encoding the signal outputted from the low noise amplifier to detect a specific identification signal;
a high gain amplifier for amplifying a signal outputted from the SAW correlator to a high gain;
a wake-up signal detector for determining whether or not a predetermined identification signal is received based on the output signals from the high gain amplifier to output the second wake-up signal for regulating the power of the main transceiver.

9. The wireless receiver according to claim 7, wherein the wake-up signal detector comprises a peak detector for detecting a peak level of the signal decoded by the SAW correlator, and if the peak level of the signal is above a predetermined level, outputting the second wake-up signal.

10. The wireless receiver according to claim 8, wherein the wake-up signal detector comprises a peak detector for detecting a peak level of the signal decoded by the SAW correlator, and if the peak level of the signal is above a predetermined level, outputting the second wake-up signal.

11. The wireless receiver according to claim 7, wherein the wake-up signal detector comprises:
an envelope detector for detecting an envelope curve of a signal decoded by the SAW correlator;
a low pass filter for eliminating a high pass noise from the signal outputted from the envelope detector;
an identification detector for determining whether or not the envelope curve passed through the low pass filter is a predetermined identification signal to output the second wake-up signal.

12. The wireless receiver according to claim 8, wherein the wake-up signal detector comprises:
an envelope detector for detecting an envelope curve of a signal decoded by the SAW correlator;
a low pass filter for eliminating a high pass noise from the signal outputted from the envelope detector;
an identification detector for determining whether or not the envelope curve passed through the low pass filter is a predetermined identification signal to output the second wake-up signal.

13. The wireless receiver according to claim 9, wherein the wake-up signal detector further comprises a switch for applying power to the main transceiver as the second wake-up signal is outputted from the peak detector.

14. The wireless receiver according to claim 10, wherein the wake-up signal detector further comprises a switch for applying power to the main transceiver as the second wake-up signal is outputted from the peak detector.

15. The wireless receiver according to claim 11, wherein the wake-up signal detector further comprises a switch for applying power to the main transceiver as the second wake-up signal is outputted from the peak detector.

16. The wireless receiver according to claim 12, wherein the wake-up signal detector further comprises a switch for applying power to the main transceiver as the second wake-up signal is outputted from the peak detector.
